(19) United States
(12) Patent Application Publication
(10) Pub. No.: US 2010/0163173 A1
(43) Pub. Date: Jul. 1, 2010

(54) HEAT BONDING FILM, METHOD OF MANUFACTURING THE SAME AND HEAT BONDING METHOD

(76) Inventor: Ju-Chen CHIU, Taipei City (TW)

Correspondence Address: Muncy, Geissler, Olds & Lowe, PLLC, 4000 Legato Road, Suite 310, FAIRFAX, VA, 22033, US

(21) Appl. No.: 12/647,263

(22) Filed: Dec. 24, 2009

Related U.S. Application Data
(60) Provisional application No. 61/140,855, filed on Dec. 25, 2008.

(51) Int. Cl. B32B 37/12; B32B 33/00; B32B 3/10; B32B 5/00; B32B 27/00; B32B 37/00

(52) U.S. Cl. 156/275.5; 428/347; 428/200; 428/337; 428/349; 428/345; 156/60; 156/324.4

(57) ABSTRACT

Disclosed herein is a heat bonding film, which includes a hot-melt adhesive film and a protective layer disposed on the hot-melt adhesive film. The hot-melt adhesive film exhibits an adhesive property after being heated. While an outer surface of the protective layer is heated, the heat bonding film may be attached onto an object through the adhesive property provided by the hot-melt adhesive film.

### CROSS-REFERENCE TO RELATED APPLICATION

This application claims the priority benefit of U.S. Provisional Application Ser. No. 61/140,855, filed Dec. 25, 2008, the full disclosures of which are incorporated herein by reference.

### BACKGROUND

1. Field of Invention

The present disclosure relates to a heat bonding film. More particularly, the present disclosure relates to a heat bonding film capable of being attached on a surface of a housing and enhancing the appearance of housing.

2. Description of Related Art

Thermal transfer technologies refer to transferring a pattern or mark of a thermal transfer film to a surface of an article. In general, a thermal transfer film having a pattern thereon is prepared first, and a pressure and a high temperature is exerted onto the thermal transfer film so that the pattern is transferred onto the surface of the article.

FIG. 1A is a cross-sectional view of a conventional thermal transfer film known in the art. The thermal transfer film 100 includes a substrate 110, a release layer 120, a decorating layer 130 and an adhesive layer 140. The release layer 120 is coated on a side of the substrate 110. The decorating layer 130 such as an ink layer or metal layer is disposed on the release layer 120. The adhesive layer 140 is coated on an outer surface of the decorating layer 130. FIG. 1B schematically illustrates the method for thermally transfer the conventional thermal transfer film 100. Firstly, the thermal transfer film 100 is placed on and covering an outer surface of an article 150, with the adhesive layer 140 being situated on the article 150. Subsequently, pressure and heat are exerted on the substrate 110 of the thermal transfer film 100 such that the adhesive layer 140 is adhered on the article 150. And then, both the substrate 110 and the release layer 120 are peeled off from the decorating layer 130. Since the adhesive force between the release layer 120 and the decorating layer 130 is lower than that between the decorating layer 130 and adhesive layer 140, the substrate 110 and the release layer 120 may be removed from the decorating layer 130, thereby leaving the decorating layer 130 on the article 150.

After the substrate 110 is peeled off, the decorating layer 130 is directly exposed to the surroundings, and thus it will be easily scribed or damaged. Therefore, an additional protective layer sprayed or coated on the decorating layer 130 is usually required to protect the decorating layer 130. However, during spraying or coating the protective layer, particles from the surroundings or some process issues usually cause defects on the product, and thus the total cost during the thermal transfer process is undesirably increased. In addition, during the spraying and baking processes of the protective layer, the evaporated organic solvent is harmful to the environment.

### SUMMARY

According to one aspect of the present disclosure, a heat bonding film is provided. The heat bonding film includes a hot-melt adhesive film and a protective layer. The protective layer is disposed on and adjacent to the hot-melt adhesive film. When subject to heat, the hot-melt adhesive film is melted and exhibits an adhesive property. In one example, the hot-melt adhesive film serves as a substrate on which the protective layer is directly disposed. When an outer surface of the protective layer is heated, the heat bonding film is operable to be adhered onto an object.

According to one embodiment of the present disclosure, the material of the hot-melt adhesive film may be ethylene vinyl acetate-based resins, polyamide-based resins, polyester-based resins, polyurethane-based resins, epoxy-based resins, polyethylene-based resins, polypropylene-based resin or thermoplastic rubbers.

In one embodiment, the protective layer is made of a radiation curing resin, an electron beam curing resin or a thermosetting resin.

In another embodiment, the protective layer includes a decorating layer positioned adjacent to the hot-melt adhesive film. In some examples, the decorating layer may be an ink layer, a metal layer, a metal sheet film, a resin sheet film or a cellulose sheet film.

According to another aspect of the present disclosure, a method for manufacturing a heat bonding film is provided. The method include the steps of: providing a hot-melt adhesive film capable of exhibiting an adhesive property while being melted by heat; disposing a protective layer on the hot-melt adhesive film; providing an energy to cure the protective layer; wherein the heat bonding film is operable to be adhered onto an object through the adhesive property while an outer surface of the cured protective layer is heated.

According to still another aspect of the present disclosure, a heat bonding method is provided. The method includes the steps of: (1) providing a heat bonding film, comprising: a hot-melt adhesive film capable of exhibiting an adhesive property when subject to heat and a protective layer disposed on the hot-melt adhesive film, wherein the hot-melt adhesive film serves as a substrate on which the protective layer is directly disposed; (2) disposing the heat bonding film on an object, wherein the hot-melt adhesive film is positioned between the protective layer and the object; and (3) heating an outer surface of the protective layer of the heat bonding film to melt the hot-melt adhesive film such that the heat bonding film is adhered onto the object through the adhesive property provided by the melted hot-melt adhesive film.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a schematic cross-sectional view of a conventional thermal transfer film known in the art.

FIG. 1B is a schematic cross-sectional view schematically illustrates the thermal transfer method according to the conventional thermal transfer film 100.

FIG. 2 is a schematic cross-sectional view illustrating a heat bonding film according to one embodiment of the present disclosure.

FIG. 3A to FIG. 3B are schematic cross-sectional views illustrating heat bonding films according to other embodiments of the present disclosure.

FIG. 4 is a schematic cross-sectional view illustrating a heat bonding film applied on a housing according to one embodiment of the present disclosure.

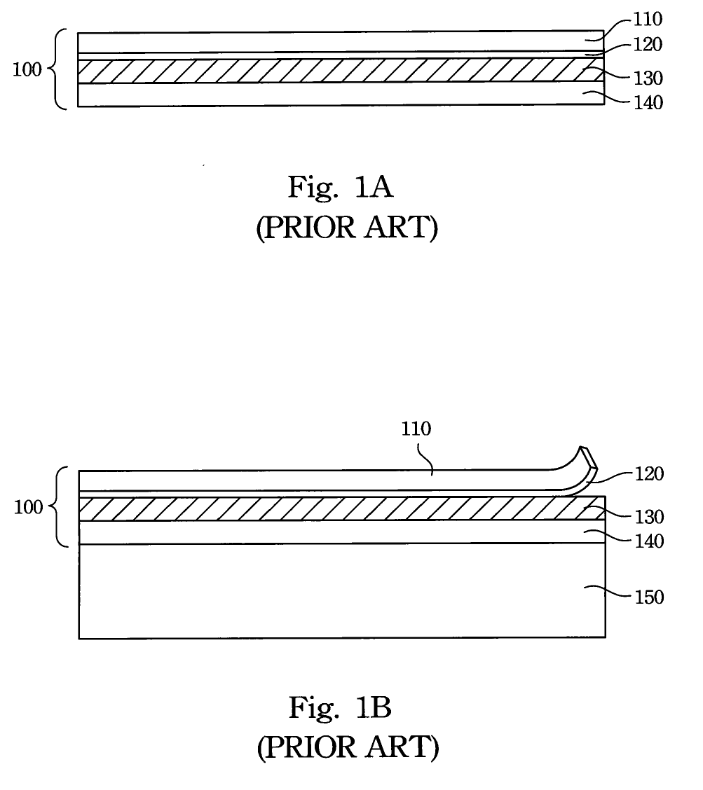

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

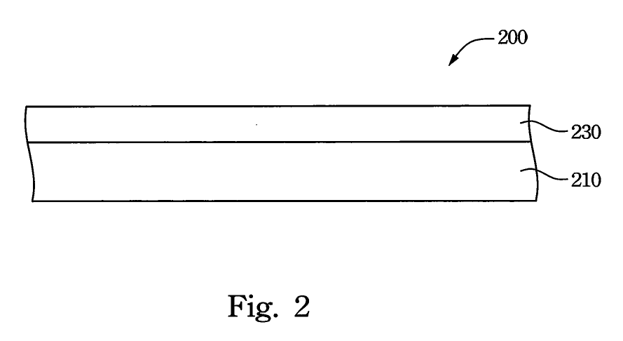

FIG. 2 is a cross-sectional view illustrating a heat bonding film 200 according to one embodiment of the present disclosure. The heat bonding film 200 disclosed herein is capable of being attached to an outer surface of a housing such as a housing of a computer, laptop or other electronic products. As depicted in FIG. 2, the heat bonding film 200 includes a hot-melt adhesive film 210 and a protective layer 230. The protective layer 230 is disposed on the hot-melt adhesive film 210, and is adjacent to the hot-melt adhesive film 210.

The hot-melt adhesive film 210 serves to adhere the heat bonding film 200 onto a surface of a housing. The hot-melt adhesive film 210 transform into a melted state while being heated, and thereby exhibiting an adhesive property. More specifically, the hot-melt adhesive film 210 exists in solid phase at a room temperature, but melts at a high temperature and has adherence when melted. However, when the temperature goes back to the room temperature, the hot-melt adhesive film 210 returns to the solid state. In the present disclosure, the hot-melt adhesive film 210 functions as both a substrate and an adhesive. The protective layer 230 may be disposed directly on the hot-melt adhesive film 210 at a normal temperature (i.e., the temperature below its melting point). But when the hot-melt adhesive film 210 is subjected to a high temperature, it may be melted and exhibit an adhesive property, and thereby adhering the heat bonding film 200 onto a surface of a housing.

Suitable materials for the hot-melt adhesive film 210 include, but are not limited to, ethylene vinyl acetate-based resins, polyamide-based resins, polyester-based resins, polyurethane-based resins, epoxy-based resins, polyethylene-based resins, polypropylene-based resin and thermoplastic rubbers.

In another embodiment, the thickness of the hot-melt adhesive film 210 is in a range of about 5 μm to about 800 μm. For instance, the thickness of the hot-melt adhesive film 210 may be about 50 μm, 100 μm, 200 μm, 300 μm, 500 μm or 700 μm. In one specific example, the hot-melt adhesive film 210 is made of a polyester-based resin and has a thickness of about 75 μm to 100 μm.

The protective layer 230 is disposed on the hot-melt adhesive film 210 to protect the housing on which the heat bonding film 200 is adhered. The protective layer 230 may be made of a transparent material or an opaque material, depending on its application. For example, in a case where a glossy appearance of a housing is desired, a transparent protective layer 230 may be employed so that the housing may have a shiny appearance. However, in another example, a pigment may be added into the protective layer 230 such that the protective layer 230 has a color capable of concealing the original appearance of the housing.

According to one embodiment of the present disclosure, the protective layer 230 may be made of a radiation curing resin or an electron beam curing resin. In one example, a layer of the radiation curing resin is formed on the hot-melt adhesive film 210 by coating the radiation curing resin on the hot-melt adhesive film 210, and then radiation energy such as ultraviolet light is projected onto the radiation curing resin. After being irradiated, the radiation curing resin layer is cured and becomes the protective layer 230. In another example, an electron beam curing resin is coated on the hot-melt adhesive film 210. Afterwards, an electron beam is projected onto the electron beam curing resin, which forms the protective layer 230 after being irradiated.

In one example, the radiation or electron beam curing resin comprises at least one monomer, examples of which include a methacrylate-based monomer, an acrylate-based monomers, a vinyl-based monomer, a vinyl-ether based monomer and an epoxy-based monomers. However, the present disclosure is not limited to the above mentioned monomers.

In one example, the radiation or electron beam curing resin comprises at least one oligomer. For example, the oligomer may be an unsaturated polyester-based oligomer, an epoxy acrylate-based oligomer, a polyurethane acrylate-based oligomer, a polyester acrylate-based oligomer, a polyether acrylate-based oligomer, an acrylated acrylic oligomer, or an epoxy-based resin oligomer. However, the present disclosure is not limited to the above mentioned oligomers.

In one specific example, the radiation curing resin includes about 60-120 weight by parts of a bifunctional acrylate-based monomer, about 60-120 weight by parts of a bifunctional epoxy acrylate-based oligomer, about 5-10 weight by parts of a photo initiator, and about 50-100 weight by parts of an ethyl acetate. For example, the radiation curing resin may include 80-100 weight by parts of bifunctional acrylate-based monomer, about 80-100 weight by parts of bifunctional epoxy acrylate-based oligomer, about 6-8 weight by parts of photo initiator, and about 60-80 weight by parts of ethyl acetate.

According to another embodiment, the protective layer 230 may be made of a thermosetting resin. Suitable materials for the protective layer 230 include, but are not limited to, acrylic-based resins, acrylic polyol based resins, vinyl-based resins, polyester-based resins, epoxy-based resins and polyurethane-based resins.

There is no specific limitation on the thickness of the protective layer 230. In one example, the thickness of the protective layer 230 is about 5-100 μl such as 10 μm, 20 μm, 30 μm, 50 μm or 80 μm.

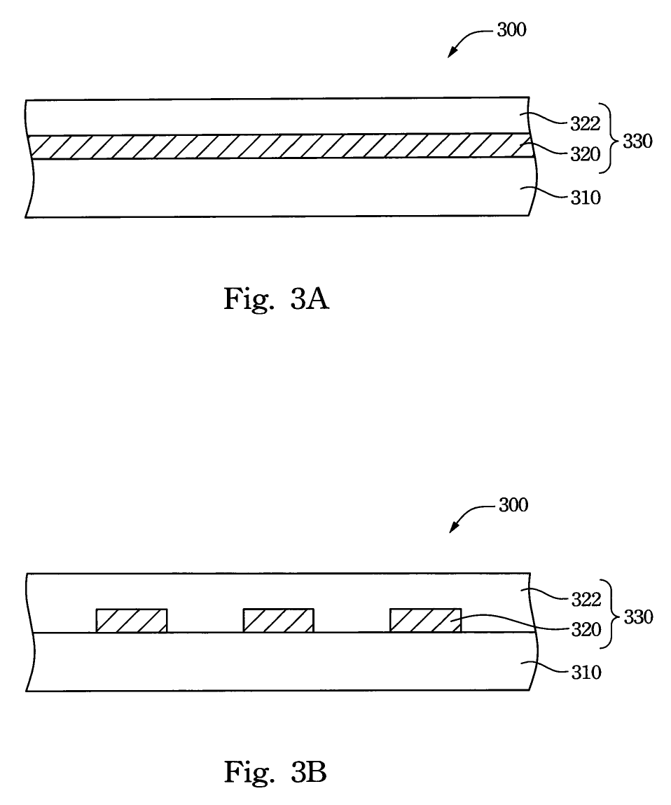

FIGS. 3A and 3B are cross-sectional views of a heat bonding film 300 according to another embodiment of the present disclosure. The heat bonding film 300 includes a hot-melt adhesive film 310 and a protective layer 330 having a decorating layer 320. In this example, the protective layer 330 includes a decorating layer 320 and a resin layer 322 (i.e. a layer of protective material), and the decorating layer 320 is positioned adjacent to the hot-melt adhesive film 310.

As depicted in FIGS. 3A and 3B, the decorating layer 320 is disposed on the hot-melt adhesive film 310 to provide a picture or pattern. The material or pattern of the decorating layer 320 is not limited since they depend on the desired picture, pattern and appearance that the heat bonding film 300 would show. The decorating layer 320 may be a continuous layer which covers the whole hot-melt adhesive film 210, as depicted in FIG. 3A. Alternatively, the decorating layer 320 may be a patterned decorating layer 320, which merely covers a portion of the hot-melt adhesive film 310, as depicted in FIG. 3B. In one example, the decorating layer 320 may be an ink layer, which is formed by printing an ink layer on the hot-melt adhesive film 310 through processes such as roller printing. In another example, the decorating layer 320 may be a metal layer, which is formed by sputtering or evaporating a metal on the hot-melt adhesive film 310. In some examples, the material of the metal layer may be gold, silver, copper, aluminum, zinc, tin or titanium. When the decorating layer 320 is a metal layer, the appearance of the heat bonding film 300 may exhibit a metallic luster.

In another example, decorating layer 320 may be a piece of sheet film such as a metal sheet film, resin sheet film or cellulose sheet film. In this example, the metal, resin or cellulose sheet film may be attached on the hot-melt adhesive film 310 by exerting a pressure or heat thereon.

In one specific example, the decorating layer 320 is a silver layer formed by the evaporation method, with a thickness of about 50-300 nm. In another specific example, the decorating layer 320 is a cellulose sheet film with a thickness of about 10 μm to about 30 μm so as to provide a fibrous-looking appearance.

The resin layer 322 (i.e. a layer of protective material) is disposed on the decorating layer 320 to protect the decorating layer 320. In the example where an ink layer is used as the decorating layer, the resin layer 322 (i.e. a layer of protective material) may protect the ink layer from being peeled-off or scribed. In the example where a metal layer is adopted as the decorating layer, the resin layer 322 (i.e. a layer of protective material) may be a transparent protective layer, which not only prevents the metal layer from being scribed but also enhances the metallic luster of the metal layer. When the decorating layer is a metal sheet film, a resin sheet film or a cellulose sheet film, the resin layer 322 may prevent these sheet films from deteriorating or being scribed. The material of the resin layer 322 may be a radiation curing resin, an electron beam curing resin or a thermosetting resin described hereinbefore.

In addition, the decorating layer 320 may be formed in the protective layer 330 in advance. For example, the decorating layer 320 may be disposed on the resin layer 322 (i.e. a layer of protective material) and thus the protective layer 330 composed of the decorating layer 320 and the resin layer 322 is fabricated in advance. Subsequently, the protective layer 330 is disposed on the hot-melt adhesive film 310. Preferably, the decorating layer 320 is positioned between the resin layer 322 and the hot-melt adhesive film 310.

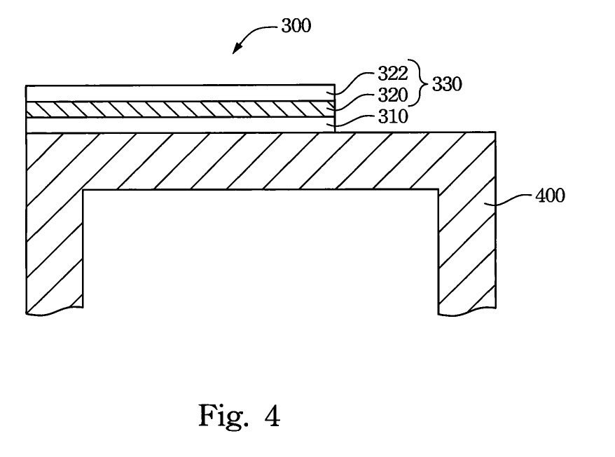

FIG. 4 is a cross-sectional view of a heat bonding film 300 applied on a housing 400 according to one embodiment of the present disclosure. As depicted in FIG. 4, the hot-melt adhesive film 310 of the heat bonding film 300 is adhered onto a surface of the housing 400. The protective layer 330 composed of the decorating layer 320 and a layer of protective material 322 is disposed on the hot-melt adhesive film 310. In one example, the decorating layer 320 is an aluminum layer formed by the evaporation method, and thus the portion of the housing 400 having the heat bonding film 300 thereon may show a metallic luster.

According to another aspect of the present disclosure, a method for manufacturing a heat bonding film is provided. The method comprises the steps of: providing a hot-melt adhesive film capable of exhibiting an adhesive property when subject to heat; disposing a protective layer directly on the hot-melt adhesive film; and curing the protective layer by an energy; wherein the heat bonding film is operable to be adhered onto an object through the adhesive property while an outer surface of the cured protective layer is heated. In one example, the above mentioned protective layer may include a decorating layer which is positioned adjacent to the hot-melt adhesive film. In the above mentioned method, the energy may be thermal energy or photo energy.

According to another aspect of the present disclosure, a heat bonding method is provided. The method comprises the steps of: (1) providing a heat bonding film, which includes a hot-melt adhesive film capable of exhibiting an adhesive property while being heated, and a protective layer disposed on and adjacent to the hot-melt adhesive film, wherein the hot-melt adhesive film serves as a substrate on which the protective layer is directly disposed; (2) disposing the heat bonding film on an object, wherein the hot-melt adhesive film is positioned between the protective layer and the object; and (3) heating an outer surface of the protective layer of the heat bonding film to melt the hot-melt adhesive film such that the heat bonding film is adhered onto the object through the adhesive property provided by the melted hot-melt adhesive film. In one example, the above mentioned method further comprises a step of applying pressure on the protective layer. In another example, the protective layer described above may further include a decorating layer, and the decorating layer is positioned adjacent to the hot-melt adhesive film.

### EXAMPLES

### Example 1

In this example, the heat bonding film 200 includes a hot-melt adhesive film 210 and a protective layer 230, as depicted in FIG. 2. The hot-melt adhesive film 210 had a thickness of 100 μm, and was made of polyester. The protective layer 230 was made from a radiation curing resin prepared by mixing about 80 weight by parts of a bifunctional acrylate-based monomer, about 100 weight by parts of bifunctional epoxy acrylate-based oligomer, about 5 weight by parts of a photo initiator, and about 100 weight by parts of an ethyl acetate (serves as a solvent), and then polymerizing the mixture to form the radiation curing resin. The radiation curing resin was coated on the hot-melt adhesive film 210, and was subsequently baked in a hot-air oven at a temperature of about 80° C. Finally, the baked radiation curing resin was irradiated by an ultraviolet light, with an energy does of about 800 mJ/cm². Thereby, the radiation curing resin was cured to obtain the protective layer 230. The thickness of the protective layer 230 may be controlled by adjusting the coating thickness of the radiation curing resin. In this example, the thickness of the protective layer 230 was about 8 μm.

### Example 2

In this example, the heat bonding film 300 includes a hot-melt adhesive film 310, a decorating layer 320 and a resin layer 322, as depicted in FIG. 3A. The hot-melt adhesive film 310 had a thickness of about 75 μm, and was made of polyester. The decorating layer 320 was an aluminum layer having a thickness of about 200 nm, and was formed by an evaporation process. The resin layer 322 was made from a transparent radiation curing resin, which was prepared by mixing about 100 weight by parts of bifunctional acrylate-based monomer, about 100 weight by parts of bifunctional epoxy acrylate-based oligomer, about 8 weight by parts of photo initiator and about 75 weight by parts of ethyl acetate (serves as a solvent), and polymerizing the mixture to form the transparent radiation curing resin. The transparent radiation curing resin was coated on the decorating layer 320, and then was baked in a hot-air oven at a temperature of about 80° C. Finally, the baked radiation curing resin was illuminated by an ultraviolet light, with an energy does of about 800 mJ/cm². The transparent radiation curing resin was cured to obtain the resin layer 322. The thickness of the resin layer 322 may be controlled by adjusting the coating thickness of the transparent radiation curing resin. In this example, the thickness of the protective layer 330 was about 10 μm.

### Example 3

In this example, the hot-melt adhesive film 310 had a thickness of about 100 μm, and was made of polyester. The decorating layer 320 is an ink layer having a thickness of about 5 μm, and was formed by a printing method. The resin layer 322 (i.e. a layer of protective material) was lastly formed on the decorating layer 320. The manufacturing method and material of the protective layer 330, which is composed of the decorating layer 320 and the resin layer 322, may be the same as those described in Example 2.

### Example 4

In this example, the hot-melt adhesive film 310 had a thickness of about 150 μm, and was made of polyester. The decorating layer 320 is a piece of cellulose sheet film so as to provide a fibrous-looking appearance, and a thickness thereof is about 20 μm. The cellulose sheet is attached on the hot-melt adhesive film 310 by exerting an external pressure on the cellulose sheet film. The resin layer 322 (i.e. a layer of protective material) is lastly formed on the decorating layer 320. The manufacturing method and material of the resin layer 322 may be the same as those described in Example 2.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A heat bonding film, comprising:
a hot-melt adhesive film capable of exhibiting an adhesive property when subject to heat; and
a protective layer disposed on and adjacent to the hot-melt adhesive film,
wherein the hot-melt adhesive film serves as a substrate on which the protective layer is directly disposed, and the heat bonding film is operable to be adhered onto an object through the adhesive property when an outer surface of the protective layer is heated.

2. The heat bonding film according to claim 1, wherein the protective layer comprises a decorating layer positioned adjacent to the hot-melt adhesive film.

3. The heat bonding film according to claim 2, wherein the decorating layer comprises an ink layer, a metal layer, a metal sheet film, a resin sheet film or a cellulose sheet film.

4. The heat bonding film according to claim 3, wherein the metal layer comprises a material selected form the group consisting of gold, silver, copper, aluminum, zinc, tin and titanium.

5. The heat bonding film according to claim 1, wherein the hot-melt adhesive film has a thickness of about 5 μm to about 800 μm.

6. The heat bonding film according to claim 1, wherein the hot-melt adhesive film comprises a material selected form the group consisting of ethylene vinyl acetate-based resins, polyamide-based resins, polyester-based resins, polyurethane-based resins, epoxy-based resins, polyethylene-based resins, polypropylene-based resin and thermoplastic rubbers.

7. The heat bonding film according to claim 1, wherein the protective layer is made of a radiation curing resin, an electron beam curing resin or a thermosetting resin.

8. The heat bonding film according to claim 7, wherein the radiation curing resin or the electron beam curing resin comprises a monomer selected form the group consisting of methacrylate-based monomer, acrylate-based monomer, vinyl-based monomer, vinyl-ether based monomer and epoxy-based monomer.

9. The heat bonding film according to claim 7, wherein the radiation curing resin or the electron beam curing resin comprises an oligomer selected from the group consisting of unsaturated polyester-based oligomer, epoxy acrylate-based oligomer, polyurethane acrylate-based oligomer, polyester acrylate-based oligomer, polyether acrylate-based oligomer, acrylated acrylic oligomer, and epoxy-based resin oligomer.

10. The heat bonding film according to claim 7, wherein thermosetting resin is selected from the group consisting of acrylic-based resins, acrylic polyol based resins, vinyl-based resins, polyester-based resins, epoxy-based resins and polyurethane-based resins.

11. A method for manufacturing a heat bonding film, comprising:
providing a hot-melt adhesive film capable of exhibiting an adhesive property when subject to heat;
disposing a protective layer directly on the hot-melt adhesive film; and
curing the protective layer by an energy,
wherein the heat bonding film is operable to be adhered onto an object through the adhesive property when an outer surface of the cured protective layer is heated.

12. The method according to claim 11, wherein the step of disposing the protective layer comprises:
positioning a decorating layer of the protective layer adjacent to the hot-melt adhesive film.

13. The method according to claim 12, wherein the decorating layer comprises an ink layer, a metal layer, a metal sheet film, a resin sheet film or a cellulose sheet film.

14. The method according to claim 11, wherein the energy is any one of thermal energy or photo energy.

15. The method according to claim 11, wherein the protective layer is made of a radiation curing resin, an electron beam curing resin or a thermosetting resin.

16. A heat bonding method, comprising the steps of:
providing a heat bonding film, comprising:
a hot-melt adhesive film capable of exhibiting an adhesive property when subject to heat; and
a protective layer disposed on and adjacent to the hot-melt adhesive film;
wherein the hot-melt adhesive film serves as a substrate on which the protective layer is directly disposed;
disposing the heat bonding film on an object, wherein the hot-melt adhesive film is positioned between the protective layer and the object; and
heating an outer surface of the protective layer of the heat bonding film to melt the hot-melt adhesive film such that the heat bonding film is adhered onto the object through the adhesive property provided by the melted hot-melt adhesive film.

17. The method according to claim 16, further comprising a step of applying pressure on the protective layer after the heating step.

18. The method according to claim 16, wherein the protective layer comprises a decorating layer positioned adjacent to the hot-melt adhesive film.

19. The method according to claim 18, wherein the decorating layer comprises an ink layer, a metal layer, a metal sheet film a resin sheet film or a cellulose sheet film.

20. The method according to claim 16, wherein the protective layer is made of a radiation curing resin, an electron beam curing resin or a thermosetting resin.
